(19) United States
(12) Patent Application Publication
(10) Pub. No.: US 2024/0167332 A1
(43) Pub. Date: May 23, 2024

(54) HORIZONTAL BLIND HAVING A HIDDEN TENSION CORD

(71) Applicant: Rhombus Beteiligungs-GmbH & Co. KG, Leinfelden-Echterdingen (DE)

(72) Inventors: Marc Horn, Heidenheim (DE); Dieter Boehm, Gollhofen (DE)

(21) Appl. No.: 18/387,829

(22) Filed: Nov. 7, 2023

(30) Foreign Application Priority Data
Nov. 17, 2022 (DE) 20 2022 106 449.0

(51) Int. Cl. E06B 9/327; E06B 9/326

(52) U.S. Cl. CPC E06B 9/327; E06B 9/326; E06B 2009/2625

(57) ABSTRACT

A plissé installation for window and door openings includes an upper rail and a lower rail between which a sun protection device adjustable in size is disposed, and a lateral profile disposed perpendicular to the longitudinal extension of the profile rails, the profile rails being disposed on a tension cord so as to be freely displaceable independently of each other along the longitudinal extension of the lateral profile, and the tension cord being directly or indirectly fastenable within the lateral profile. A guide blade is disposed on the profile rail protruding into the lateral profile via an opening to guide the profile rail along the lateral profile, and the tension cord being guided through the sun protection device, through the lateral profile and through the profile rails so as to be inaccessible.

This application claims priority to German utility model application no. 20 2022 106 449.0 filed on Nov. 17, 2022, the disclosure of which is incorporated by reference.

### TECHNICAL FIELD

The invention relates to a plissé installation.

### BACKGROUND

Generic plissé installations are used in particular as a visibility barrier, a visor, for darkening and/or for shading glazed windows or doors. Aside from this, generic plissé installations are also used for comparable objects, such as glass façades or partition walls.

Generically, plissé installations are fastened on a pane and/or frame on the inner side of a window, a door or similar objects. For this purpose, the shading can be based on the use of a planar formation, which is pleated multiply and thus has a plurality of essentially parallel pleats. At at least one end of the planar formation, a profile rail is provided, which is oriented parallel to the pleats of the planar formation. For this purpose, the planar formation and the profile rail are mounted in such a manner that the profile rail can be displaced perpendicular to the pleats of the planar formation in order to enlarge or reduce the shaded surface as required in this manner. When displacing the profile rail, the planar formation is pulled apart or pushed together continuously, the length being compensated by the plurality of parallel pleats. If no force acts on the profile rail, the profile rail remains fixated in its mounting. The displacement of the profile rail can be limited by a counter-surface, against which the profile rail can abut. This counter-surface can be formed by, for instance, the inner side of the window or door frame or additional abutment elements. If the profile rail abuts against the counter-surface, the corresponding end position has been reached in this regard.

In known plissé installations, the profile rails are guided essentially by only one tension cord and the tension cord ends are fastened in the corners of the surface to be shaded, for example in the corners of a window, by means of tension shoes, meaning the tension cord is accessible to the user in the mounted state of the plissé installation, whereby an increased risk of injury persists, for example a choking hazard in particular for children, and applicable safety regulations, in particular the Canadian regulation “M22 Corded Window Coverings” can no longer be fulfilled. Equally, connections provided on generic installations, such as between a tension shoe cap and an end lid, can be easily removed, which on the one hand leads to the tension of the tension cord unintentionally being cancelled and thus, on the other hand, can increase the risk of contusions owing to the accessibility of the interior of the plissé installation. Moreover, generic installations often have openings which are accessible at least to children, whereby in turn the risk of injury is increased by the possibility of being able to touch interior components.

### SUMMARY

Starting from this state of the art, it is therefore the object of the invention at hand to propose a universally implementable and visually appealing plissé installation, which enables minimizing the risk of injury, in particular for children. Moreover, the plissé installation should be able to be easily and inexpensively produced and be easily and reliably mounted.

This object is attained by a plissé installation.

The plissé installation according to the invention for window and door openings comprises two profile rails, in particular an upper rail and a lower rail, between the both of which a sun protection device adjustable in size is disposed. Further, the plissé installation according to the invention comprises a lateral profile disposed perpendicular to the longitudinal extension of the profile rail, the profile rails being disposed on a tension cord so as to be freely displaceable independently of each other along the longitudinal extension of the lateral profile, and the tension cord being directly or indirectly fastenable within the lateral profile. The plissé installation according to the invention is based on the fundamental idea that a guide blade is disposed on the profile rail, the guide blade protruding into the lateral profile via an opening of the lateral profile in order to guide the profile rail along the lateral profile, and the to tension cord being guided through the sun protection device, through the lateral profile and/or through the profile rail so as to be inaccessible. In the scope of the invention, it has been acknowledged that, undesirably, a tension cord passing through a simply pleated planar formation is more easily accessible than a tension cord passing through a planar formation having honeycombed pleats, as the honeycombed pleats entirely surround the tension cord.

The opening of the lateral profile extends along the longitudinal extension of the lateral profile, the lateral profile essentially being C-shaped. In other words, when viewing the cross section of the lateral profile, the lateral profile is preferably closed on three sides and has the opening in a fourth wall. For this purpose, the opening is further preferably disposed on the wall of the lateral profile oriented towards the sun protection device. It is conceivable that the lateral profile has an additional leg, namely a covering leg, protruding beyond the essentially C-shaped base body of the lateral profile and serving to enlarge the abutment surface of the lateral profile. Preferably, two lateral profiles are provided, the openings of the lateral profiles further preferably facing each other. By means of the guide blade, which protrudes from the profile rail and protrudes into the lateral profile, the profile rail can be easily moved in a guided manner along the lateral profile. The opening is preferably designed such that enough space remains for the guide blade to be inserted in the lateral profile and to slide within the lateral profile and in particular in the opening in order to allow easily displacing the profile rail along the lateral profile. The guide blade is preferably disposed on a front face of the profile rail, further preferably at both front faces of the profile rail.

According to the invention, the tension cord extends through the sun protection device, through the lateral profile and through the profile rail so as to be inaccessible. Further preferably, the tension cord extends within the lateral profile and the profile rail.

Within the scope of the invention, the term ‘inaccessible’ means that a user or in particular a child cannot reach the tension cord when the plissé installation is mounted or that the length of an accessible tension cord section does not allow injuries and in particular choking or is so short that choking can be precluded. For instance, choking, in particular of children, can be precluded at a maximal length of 220 millimeters of an accessible tension cord section according to the Canadian safety regulation “M22 Corded Window Coverings”.

Within the scope of the invention, the term ‘tension cord’ refers in particular, though by no means exclusively, to tension cords, tension straps, tension cables, tension wires and/or tension lanyards. Preferably, a tension cord is guided in the sun protection device through both the profile rail and through openings which are introduced parallel to the profile rail. The tension cords serve, on the one hand, for supporting the sun protection device and, on the other hand, for ensuring a horizontal position of the profile rails before or after actuating the plissé installation. This prevents an inclined position of the profile rails and generates a visually appealing look of the entire plissé installation. In which manner a tension cord is guided through the profile rail and the planar formation is generally arbitrary. From the state of the art, C- and Z-shaped guides are known which are also preferably used within the scope of the invention. The plissé installation according to the invention preferably has an even number of tension cords. Further preferably, the plissé installation according to the invention has at least four tension cords, two tension cords extending from the upper left corner to the lower right corner and two other tension cords extending from the upper right corner to the lower left corner. Alternatively, six tension cords can be provided. It is also conceivable for a plissé installation, in particular in custom-made products, to have one extra tension cord or one tension cord less. Within the scope of the invention, the term ‘plissé installation’ also pertains to venetian blinds, Roman blinds or similar sun protection installations for the interior.

Owing to the fact that the tension cord is guided through the sun protection device, through the lateral profile and through the profile rail so as to be inaccessible and the tension cord ends are fastened within the lateral profile, the tension cord is inaccessible to a user in the mounted state of the plissé installation at any location and independently of the position of the profile rails.

In other words, this means that the tension cord is covered by the sun protection device, the lateral profile and the profile rail, independently of the actuation of the sun protection device and the size of the adjustable sun protection device and the position of the profile rails, at least in such a manner that the length of the exposed tension cord sections is so short that choking or other injuries can be precluded. Furthermore, the user comfort is increased while simultaneously a safe guiding of the profile rails in the lateral profile is ensured. Moreover, the lateral profiles can be easily fastened to the surface to be shaded, meaning the plissé installation can be universally mounted. In particular, unlike in generic installations, the tension shoes holding the tension cords do not have to be installed at the surface to be shaded, for example at a window or its window frame; it merely suffices to mount the lateral profiles, whereby no additional fastening elements, such as window bar supports, angle brackets, clamp brackets, window clips or adhesive supports, are required. The lateral profiles are preferably fastened to the surface to be shaded by means of an adhesive connection or a screw connection. Via the solution according to the invention, in particular via the guiding of the profile rails in the lateral rails, the plissé installation according to the invention can be used not only in swivel windows or pivot-hung windows as well as doors and pivot-hung doors, but also advantageously in skylights. Furthermore, aside from the known mounting option, the plissé installation according to the invention can be mounted directly at the surface to be shaded, for instance at a window sash or on a window pane, as well as at the frame of a door or of a window or at an alcove, in which a door or a window is disposed.

Advantageous embodiments of the invention are the subject matter of the dependent claims.

According to an advantageous embodiment, an end cap is disposed on a front face of the profile rail, the guide blade being disposed on the end cap. Via the end cap, profile rail and guide blade, and thus profile rail and lateral profile, can be easily connected. Preferably, the end cap can be inserted on the profile rail and can be secured within the profile rail by means of a clamp connection and/or a snap connection. The guide blade is further preferably made in one piece with the end cap in order to minimize the number of connection locations and to thus further increase safety.

In order to allow simple mounting and a largest possible displacement area of the profile rails, it has been acknowledged as being advantageous that the opening in the lateral profile extends over the entire longitudinal extension of the lateral profile. For this purpose, the person skilled in the art is aware that the longitudinal extension of the lateral profile runs perpendicular to the longitudinal extension of the profile rails. Preferably, the opening is slot-shaped. Further preferably, the opening in the lateral profile has a clear width of maximally 20 millimeters, maximally 19 millimeters, maximally 18 millimeters, maximally 17 millimeters, maximally 16 millimeters, maximally 15 millimeters, maximally 14 millimeters, maximally 13 millimeters, maximally 12 millimeters, maximally 11 millimeters, maximally 10 millimeters, maximally 9 millimeters, maximally 8 millimeters, maximally 7 millimeters, maximally 6 millimeters or maximally 5 millimeters. Even more preferably, the slot-shaped opening in the lateral profile has a clear width of maximally 8.7 millimeters in order to preclude invasion, for example by a child's fingers. The width of the opening can be adjusted to the respectively applicable safety regulations. It is conceivable for the width of the guide blade to be designed so as to be complementary to the width of the opening.

In order to ensure that the tension cord is safely guided, it has proven advantageous when the guide blade has a recess for guiding the tension to cord. This allows safely guiding the tension cord from the profile rail and diverting it within the lateral profile. In other words, since the profile rails and the lateral profile are disposed so as to essentially be perpendicular to each other, it is necessary to divert the tension cord within the lateral profile, which can be easily achieved by the recess in the guide blade. Preferably, the recess is disposed on the end of the guide blade farthest from the profile rails. Further preferably, the recess is slot-shaped. Even more preferably, the slot of the slot-shaped recess is formed complementarily to the thickness of the tension cord.

According to an advantageous embodiment, an end lid is disposed on a front face of the lateral profile in order to fasten a tension fitting for the tension cord. Preferably, an end lid is disposed on both front faces of the lateral profile. The end lid allows, on the one hand, a visually appealing and safe capping of the lateral profile and, on the other hand, the reliable mounting of the tension fitting. The tension fitting serves for fixating the tension cord and thereby allows tensioning the tension cord and maintaining the tension of the tension cord. Preferably, the tension fitting can be connected to the end lid via a snap connection.

In order to safely fasten the tension cord, it has proven advantageous when the tension fitting has a tension shoe cap and a tension shoe cap adapter within the lateral profile. The tension shoe cap can be formed in one piece with the tension shoe cap adapter. Alternatively, the tension shoe cap and the tension shoe cap adapter are connectable to one another, preferably by means of a snap connection. Owing to this, the tension shoe lid, at which the tension cord is fastenable, can be indirectly fastened at the end lid via the tension shoe cap adapter and also at the lateral profile via the end lid. In this context, the tension shoe cap and the tension shoe cap adapter are preferably disposed within the lateral profile and thus are inaccessible from the outside when the plissé installation is mounted. Thus, the tension cord can be easily held and tensioned between the tension shoe caps connected to the end lids so that the tension cord is inaccessible.

A particularly easy and safe connection between the tension shoe cap adapter and the end lid can be achieved by means of a snap connection. Preferably, at least one snap protrusion is disposed on the tension shoe cap adapter for establishing the snap connection, the snap protrusion being engageable in a snap recess on the end lid. Further preferably, the tension shoe cap adapter has two snap protrusions, which are engageable in two snap recesses at the end lid. To establish the snap connection, it is intended to join the tension shoe cap adapter and the end lid by means of a linear insertion movement of the tension shoe cap adapter into the end lid. However, it is also conceivable to screw and/or tilt the tension shoe cap adapter into the end lid.

Moreover, it is conceivable for the tension shoe cap adapter to have an inclination which is both formed and disposed in such a manner that the tension shoe cap adapter is initially pushed towards the side of the end lid capping the lateral profile when separating the tension shoe cap adapter from the end lid, whereby the tension of the tension cord is initially further increased.

In order to economize on further connections, the end lid and the tension shoe cap adapter can be formed in one piece. It is also conceivable to form the tension fitting and the end lid in one piece.

In order to establish a simple and safe connection between the end lid and the lateral profile, it has proven advantageous to provide a snap connection between the end lid and the lateral profile. For this purpose, the end lid has a snap arm, which is engageable in a snap opening of the lateral profile. In other words, it is thus possible to easily push the end lid into the lateral profile until the snap arm snaps into the snap opening and thus secures the end lid within the lateral profile. Preferably, the snap opening is formed as a drill hole, the snap arm having a snap element formed complementarily to the drill hole.

In order to protect the tension fitting from dirt and from being accessed from the exterior and moreover to achieve a visually appealing general appearance, it has proven advantageous when the tension fitting is disposed within the lateral profile so as to be inaccessible and/or the lateral profile ends flush by means of the end lid. Preferably, the tension fitting is disposed within the lateral profile so as to be inaccessible and the lateral profile ends flush by means of the end lid. Further preferably, the end lid has a flat outer surface as an end surface, the outer surface being formed so as to be complementary to the outer contour of the lateral profile.

According to a preferred embodiment, a handle element for adjusting the height of the profile rail is disposed on the profile rail. Via the handle element, a profile rail can be easily displaced and thus the size of the sun protection device can be varied. Depending on the safety regulations and requirements, the handle element can be inserted on the profile rail or can be fastened to the profile rail by means of a screw connection. In order to ensure a safe connection between the profile rail and the handle element and a safe actuation of the handle element, the handle element preferably is made of metal, in particular aluminum, wood or plastic.

In order to further increase the safety of the plissé installation, it has proven advantageous when the connection between the lateral profile and the end lid and/or the connection between the handle element and the profile rail and/or the connection between the end cap and the profile rail and/or the connection between the tension shoe cap adapter and the end lid is designed so as to not be manually disconnectable. Within the scope of the invention, the term ‘not manually disconnectable’ means that the connection cannot be disconnected without tools solely by mustering manual force. For instance, according to the Canadian safety regulation “M22 Corded Window Coverings”, a connection is deemed to not be manually disconnectable when the connection is realized such that a force of at least 90 Newton is required to disconnect the connection. Preferably, therefore, the connection between the lateral profile and the end lid and/or the connection between the handle element and the profile rail and/or the connection between the end cap and the profile rail and/or the connection between the tension shoe cap adapter and the end lid is established such that a force of at least 90 Newton is required to disconnect the connection. In other words, this means that the aforementioned connections, such as a snap connection between the lateral profile and the end lid and/or a screw connection between the handle element and the profile rail and/or a clamp connection between the end cap and the profile rail and/or a snap connection between the tension shoe cap adapter and the end lid, cannot be manually disconnected as long as a force of at least 90 Newton has not been mustered. Further preferably, the connection between the lateral profile and the end lid and the connection between the handle element and the profile rail and the connection between the end cap and the profile rail and the connection between the tension shoe cap adapter and the end lid are designed so as to not be manually disconnectable; even more preferably designed such that a force of at least 90 Newton is required to disconnect the connection. It is to be presumed that especially children cannot muster a force of more than 90 Newton, for which reason a particularly childproof plissé installation can consequently be provided.

According to a preferred embodiment, the lateral profile has an additional cover leg, which protrudes outward from the essentially C-shaped base body of the lateral profile in order to enlarge the abutment surface of the lateral profile and/or for covering light gaps. The covering leg can, on the one hand, increase the stability of the fastening of the lateral profile and, on the other hand, can also cover the light gap between the profile rail and/or the sun protection device and the lateral profile in a visually appealing manner.

According to a preferred embodiment, the sun protection device is formed by a plissé hanging having an unfoldable and foldable, multiply pleated planar formation having a plurality of parallel pleats. Alternatively, the sun protection device can be formed by a plurality of lamellae, whose inclination can be adjusted.

To define the end position of the profile rails, it has proven advantageous when the guide blade and the end lid are connected to one another by means of a disconnectable snap connection, the guide blade being brought into contact at an undercut of the end lid. Upon reaching the end position, the guide blade and consequently the profile rail can be held in the end position at the end lid. Preferably, the outer contour of the guide blade has at least one bow-shaped section, which allows the guide blade to be tilted within the opening in the lateral profile. By tilting the guide blade, e.g., by means of the handle element, the snap connection between the guide blade and the end lid can be easily disconnected and the profile rail can be displaced again. Further preferably, two opposite sections of the outer walls of the guide blade are bow-shaped. In other words, according to this other preferred embodiment, the guide blade has at least one section having a convex outer contour in order to allow a tilting with respect to the end lid, in particular with respect to the undercut of the end lid.

To prevent contusions, for example of fingers, between the lateral profile and the profile rail, it has proven advantageous when the clear width between two lateral profiles is maximally twenty millimeters wider than the length of the profile rail. In the scope of the invention, the clear width between two lateral profiles is defined as the distance between the two openings of the lateral profiles, which is to be measured perpendicular to the longitudinal extension of the lateral profiles. In the scope of the invention, it has been acknowledged that the larger the difference between the length of the profile rail and the clear width between the lateral profiles is chosen, the longer and higher the guide blade has to be designed to make it sufficiently stable. Further, it has been acknowledged that the longer the guide blade is, the wider the lateral profile has to be designed to ensure sufficient stability, and the more the covering leg has to protrude beyond the base body of the lateral profile to cover the light gap between the lateral profile and the profile rail and/or the sun protection device. Preferably, the clear width between two lateral profiles is maximally 19 millimeters, maximally 18 millimeters, maximally 17 millimeters, maximally 16 millimeters, maximally 15 millimeters, maximally 14 millimeters, maximally 13 millimeters, maximally 12 millimeters, maximally 11 millimeters, maximally 10 millimeters, maximally 9 millimeters, maximally 8 millimeters, maximally 7 millimeters, maximally 6 millimeters or maximally 5 millimeters wider than the length of the profile rail. Even more preferably, the clear width between two lateral profiles is maximally 8.7 millimeters wider than the length of the profile rail. In other words, this means that even if the profile rail abuts against one side at a first lateral profile, merely an access gap of maximally eight millimeters is provided on the opposite side of the profile rail between the profile rail and the second lateral profile. It has been acknowledged in the scope of the invention that this access gap is so small that access to this access gap, in particular by the fingers of a child, can be precluded.

According to a preferred embodiment, the plissé installation has two lateral profiles, four end lids and four tension fittings. This allows an easy and stable construction of the plissé installation by applying one of the four tension fittings to each corner of the surface to be shaded and one of the lateral profiles to each lateral edge of the surface to be shaded. Preferably, the mounting takes place by the two lateral profiles first being fastened to a stable base, for example, a window alcove, a window frame or a window sash, in particular via adhesion or screwing. Subsequently, the profile rails can be inserted into the lateral profiles via the guide blade by means of a twisting motion with respect to the horizontal together with the sun protection device disposed on the profile rails. The tension cords fastened at the tension shoe cap can thereafter be fastened to the end lids fastened at the ends of the lateral profiles via the tension shoe cap adapter.

It is presumed that the definitions and descriptions of the terms mentioned above apply to all aspects described in this description in the following, provided it has not been stated otherwise.

Further details, features and advantages of the invention are derived from to the following description of the preferred exemplary embodiments in connection with the dependent claims. For this purpose, the corresponding features can be realized on their own or several can be realized in combination with each other. The invention is not limited to the exemplary embodiment. The exemplary embodiment is schematically shown in the figures. The same reference numerals in the individual fingers pertain to elements which are the same, have the same function and/or correspond to one another regarding their function.

### BRIEF DESCRIPTION OF DRAWINGS

In the figures, specifically

FIG. 1 shows an isometric view of a plissé installation according to the invention;

FIG. 2 shows a front view of the plissé installation according to FIG. 1;

FIG. 3 shows a cut view of a detail of the plissé installation according to FIG. 1;

FIG. 4 shows a lateral, enlarged view of the guide blade of the plissé installation according to FIG. 1;

FIG. 5 shows an exploded view of an end lid, a tension shoe cap adapter and an upper section of a lateral profile of the plissé installation;

FIG. 6 shows an isometric view of an upper section of a lateral profile of the plissé installation with an engaged end lid;

FIG. 7 shows an isometric view of a tension shoe cap adapter of the plissé installation according to FIG. 1;

FIG. 8 shows an isometric view of a tension fitting of the plissé installation according to FIG. 1;

FIG. 9 shows a cut view of an end lid of the plissé installation according to the invention with an engaged tension fitting;

FIG. 10 shows an isometric view of a detail of the plissé installation with the profile rail in the end position;

FIG. 11 shows an enlarged view of detail A from FIG. 9;

FIG. 12 shows a lateral profile of the plissé installation according to FIG. 1 prepared for a front mounting by means of an adhesive connection;

FIG. 13 shows a lateral profile of the plissé installation according to FIG. 1 prepared for an alcove mounting by means of an adhesive connection;

FIG. 14 shows a lateral profile of the plissé installation according to FIG. 1 prepared for a front mounting by means of an screw connection; and

FIG. 15 shows a lateral profile of the plissé installation according to FIG. 1 prepared for an alcove mounting by means of a screw connection.

### DETAILED DESCRIPTION

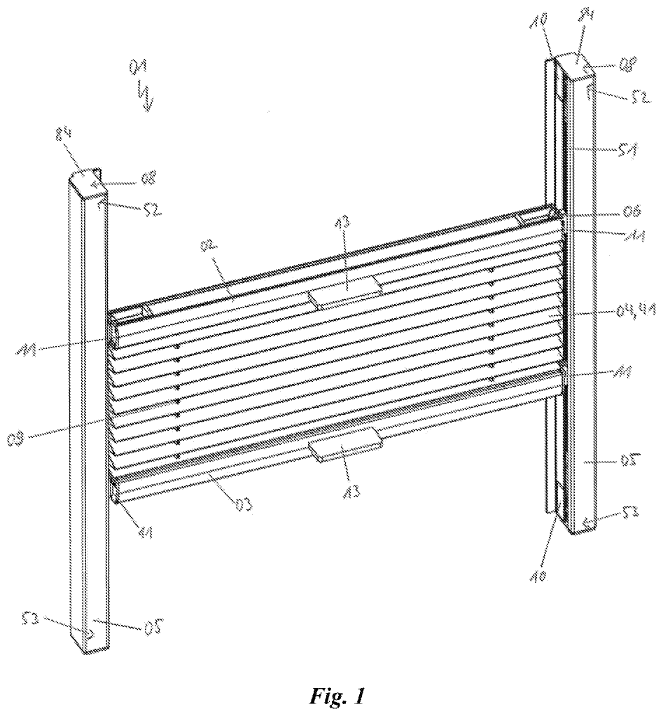

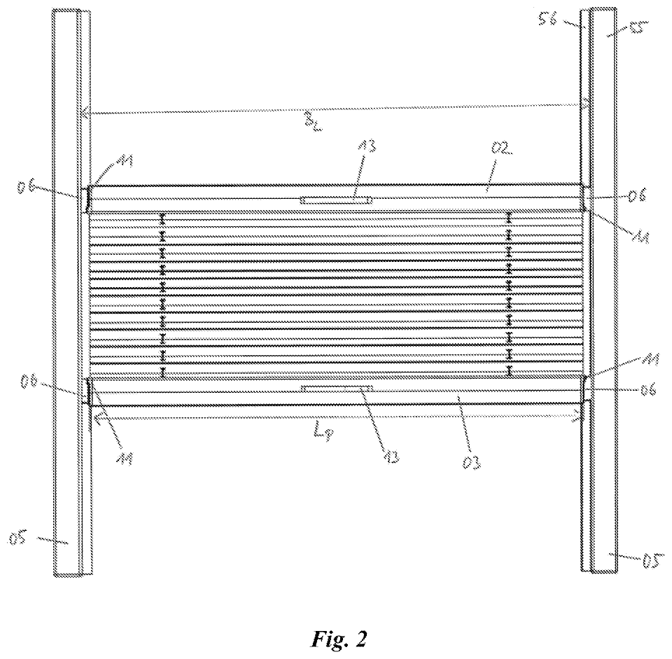

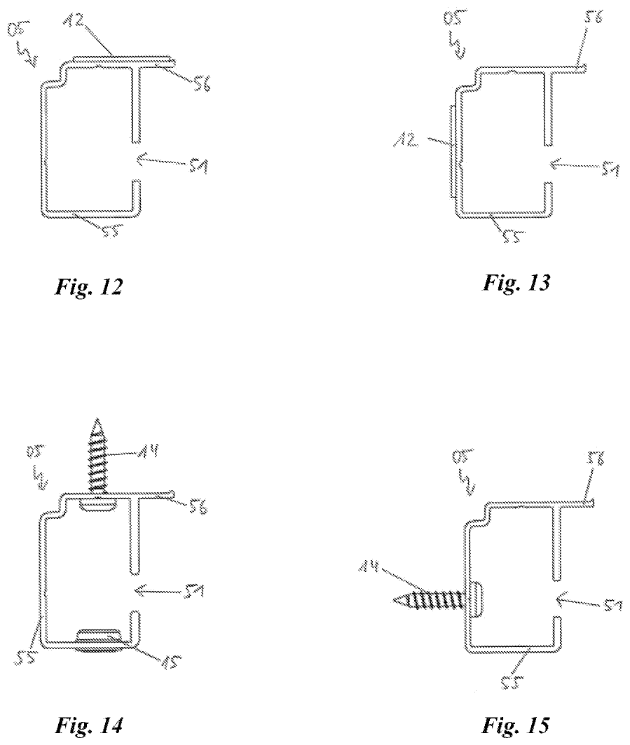

FIG. 1 and FIG. 2 show the general design of a plissé installation 01 according to the invention having a plissé hanging 41, which forms sun protection device 04. At the upper and lower end of sun protection device 04, a profile rail 02, 03 is provided which is oriented parallel to the pleats of plissé hanging 41. During actuation of plissé installation 01, profile rails 02, 03 are displaceable along lateral profiles 05 in a guided manner via end caps 11 disposed on the front faces of profile rails 02, 03 and via guide blades 06 disposed on end caps 11. Two of overall four guide blades 06 protrude into opening 51 of left lateral profile 05, and the remaining two guide blades 06 protrude into opening 51 of right lateral profile 05, slot-shaped opening 51 which extends over the entire longitudinal extension of lateral profile 05 being designed such that guide blades 06 can slide unhindered therein. Lateral profiles 05 can be mounted in different manners for shading the surface to be shaded, as shown in FIGS. 12 to 15, for example. For actuating plissé installation 01, a handle element 13 is disposed on upper profile rail 02, namely upper rail 02, and on lower profile rail 03, namely lower rail 03. In order to return handle element 13 and profile rails 02, 03 to a straight position after actuation of plissé installation 01 and to support sun protection device 04, tension cords 09 extend in left and right lateral profile 05 of plissé installation 01. Tension cords 09 are held at tension shoe caps 101 of tension fittings 10 disposed within lateral profiles 05 and extend from lower end 53 of a lateral profile 05 through lower rail 03 and through openings in plissé hanging 41 disposed parallel to lateral profile 05 through upper end strip 02 and end in a tension fitting 10 disposed at upper end 52 of a lateral profile 05. Tension fittings 10 are disposed at end lids 08, which in turn are inserted in lateral profiles 05. End caps 11 entirely cover the front faces of profile rails 02, 03, while end lids 08 entirely cover the front faces of lateral profiles 05 present at upper ends 52 and lower ends 53. It can be seen in FIGS. 1 and 2 that tension cords 09 are not accessible to a user, in particular a child, at any location of plissé installation 01.

Additionally, the stability is increased and the visual appearance is upgraded in the embodiment at hand by end strips 02, 03 being guided at two lateral profiles 05, whereby it is easily prevented that profile rails 02, 03 and/or sun protection device 04 swing into the space to be shaded, whereby, on the one hand, the function and, on the other hand, the visual appearance would be impaired. Another visual upgrade is achieved by the plane end of the lateral profiles at upper end 54 and lower end 53 by means of plane end surface 84 of end lid 08.

FIG. 2 shows the embodiment known from FIG. 1, however, in a front view. It can be seen that upper profile rail 02 and lower profile rail 03, between which planar formation 04 is disposed, are guided in lateral profiles 05 via guide blades 06. To prevent injuries, such as pinching a finger between lateral profile 05 and profile rail 02, 03, the clear width B_{L} between two lateral profiles 05 in the shown exemplary embodiment is maximally eight millimeters wider than the length L_{P} of profile rails 02, 03. As shown, clear width B_{L} between two lateral profiles 05 is measured between both openings 51 of lateral profiles 05 and perpendicular to the longitudinal extension of lateral profiles 05. When profile rails 02, 03 are positioned as shown in FIG. 2, an access gap is provided to the right and to the left, which is maximally four millimeters wide. If profile rail 02, 03 is moved towards one of the two lateral profiles 05, a lateral abutment of an end of profile rail 02, 03 at lateral profile 05 can occur, meaning an access gap, which is maximally eight millimeters wide, is only present at the opposite end of profile rail 02, 03.

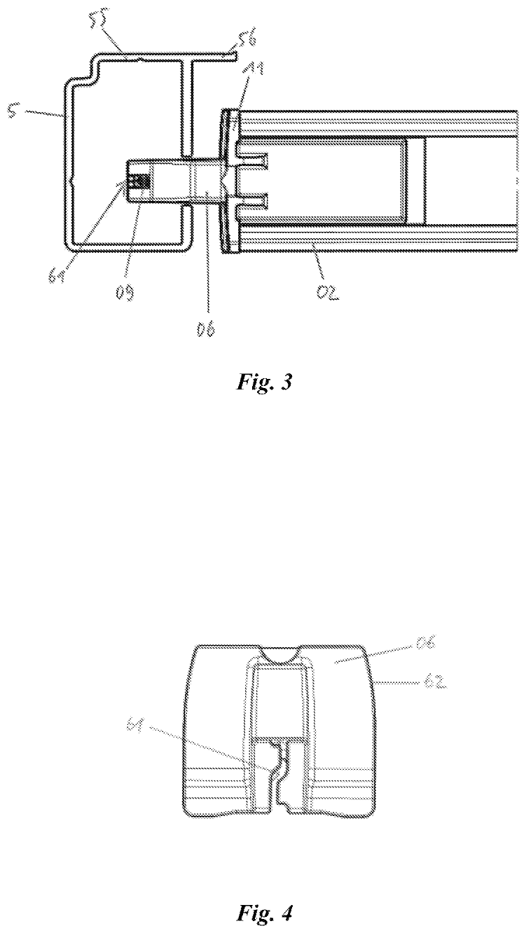

FIG. 3 shows a cut view of a detail of plissé installation 01 according to FIG. 1. Lateral profile 05 has an essentially C-shaped base body 55, lateral profile 05 additionally having a cover leg 56 for enlarging the abutment surface, e.g., at a window frame or a wall, and thus for facilitating mounting and increasing stability. Cover leg 56 extends over the entire longitudinal extension of lateral profile 05 and protrudes from lateral profile 05 towards the other lateral profile 05 and/or towards profile rail 02, 03, whereby cover leg 56 covers the light gap between profile rail 02 and/or sun protection device 04 and lateral profile 05 over the entire longitudinal extension of lateral profile 05. At the end of profile rail 02 shown in FIG. 3, an end cap 11 is disposed, which is made in one piece with guide blade 06. Guide blade 06 protrudes into lateral profile 05 through opening 51 for guiding profile rail 02 along lateral profile 05. At the end of lateral profile 05 farthest from profile rail 02, guide blade 06 has a recess 61, by means of which tension cord 09 is deviated. With reference to FIGS. 1 and 2, tension cord 09 extends essentially horizontally through profile rail 02, 03 and essentially vertically through lateral profile 05. Via guide blade 06, tension cord 09 can be guided from profile rail 02, 03 into lateral profile 05, and a guided deviation can take place between the horizontal and vertical course of tension cord 09 by means of recess 61.

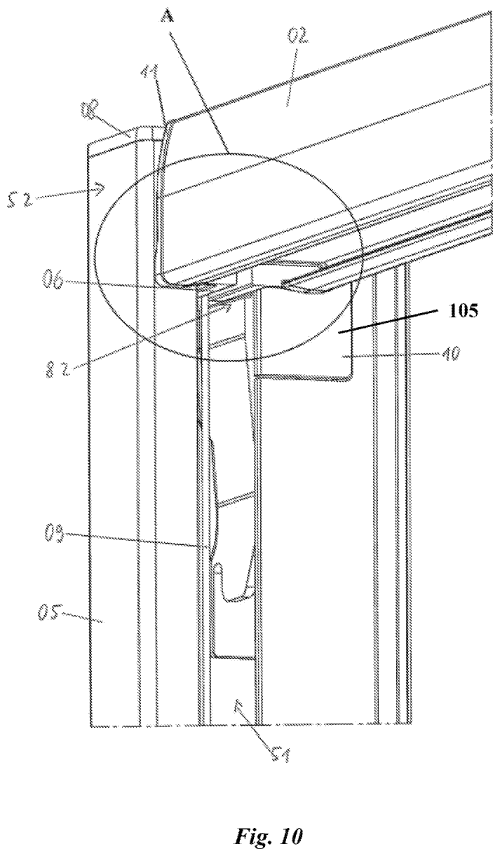

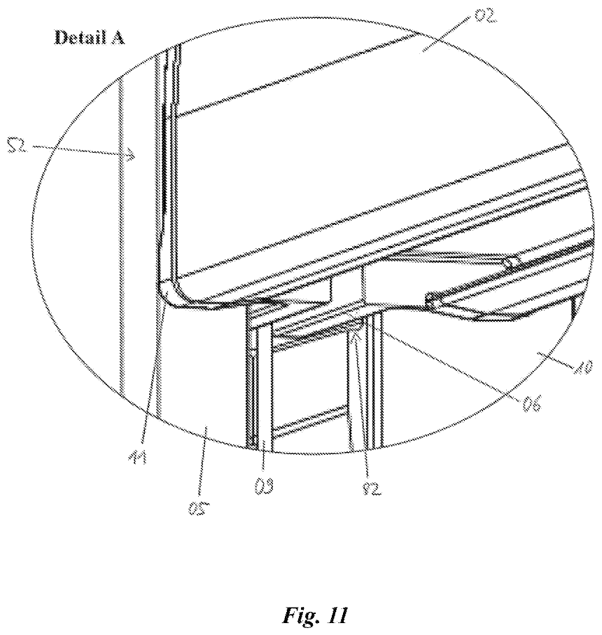

FIG. 4 shows an enlarged lateral view of guide blade 06 of plissé installation according to FIG. 1, the end of guide blade 06 which protrudes into lateral profile 05 being shown. As previously described in FIG. 3, guide blade 06 has a recess 61 for guiding and deviating tension cord 09 (not shown in this instance). Moreover, it can be seen that guide blade 06 has two bow-shaped outer walls 62. Bow-shaped outer walls 62 allow tilting the guide blade with respect to opening 51 and/or with respect to end lid 08, in particular in an end position of profile rail 02, 03, as shown in FIGS. 10 and 11. The combined view of FIG. 4 and FIGS. 10 and 11 shows that upon reaching an end position of profile rail 02, 03, guide blade 06 can be brought into contact at an undercut 82 of end lid 08. In other words, guide blade 06 snaps into undercut 82, whereby both guide blade 06 and profile rail 02, 03 connected with guide blade 06 can be held in the end position at cover lid 08. Owing to the design according to the invention of guide blade 06, in particular owing to the bow-shaped outer walls 62, guide blade 62 can be tilted with respect to undercut 82, whereby the snap connection between undercut 82 and guide blade 06 can be disconnected.

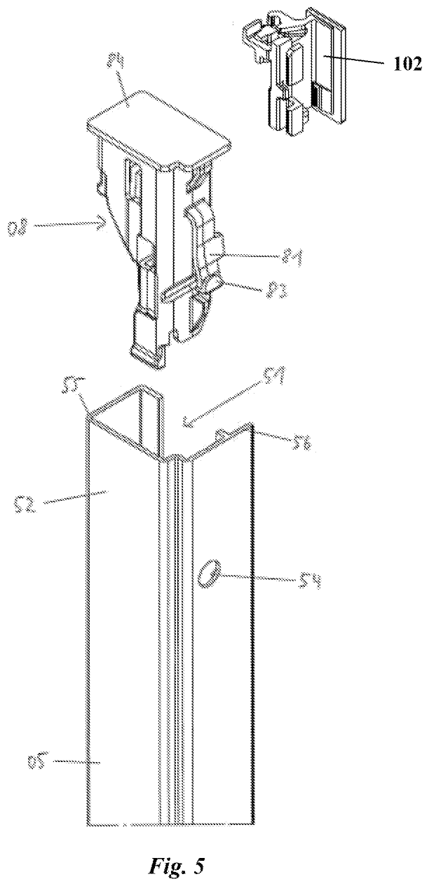

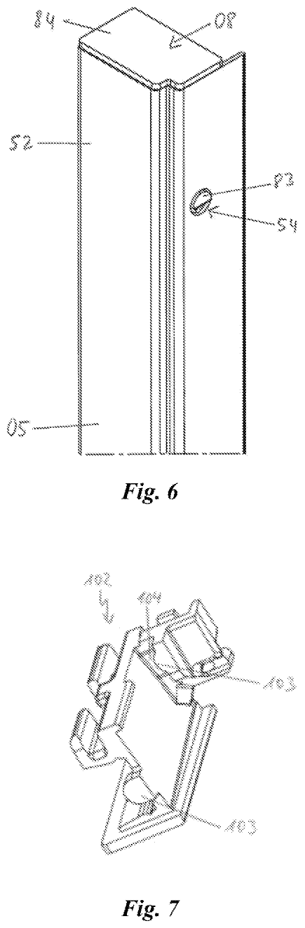

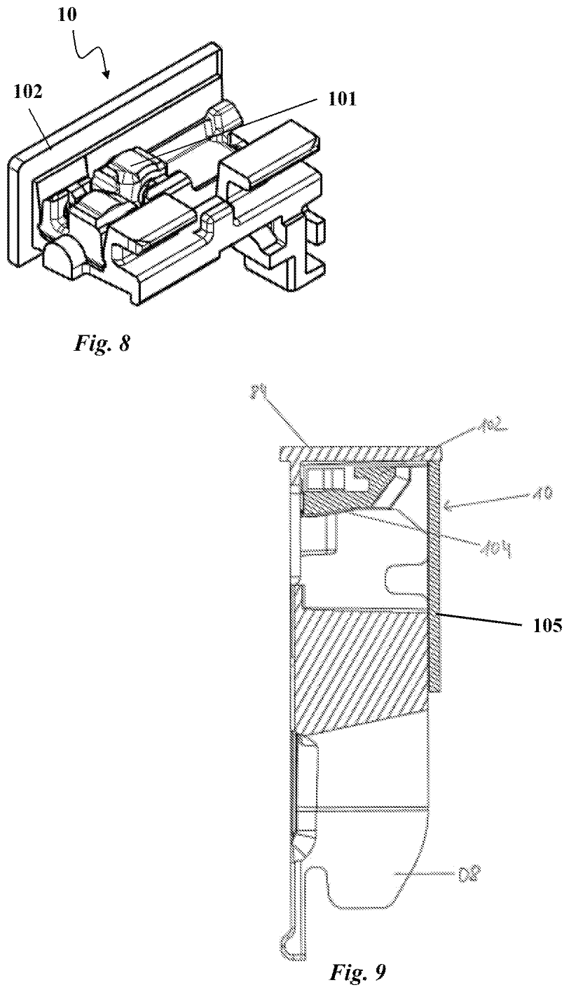

A combined view of FIGS. 5 to 9 shows the structure of tension fitting 10 and cover lid 08 in detail. As previously described with reference to FIGS. 1 and 2, cover lid 08 has a flat end surface 84 for closing lateral profile 05 in a visually appealing manner. In contrast, end wall 105 of tension fitting 10 closes opening 51 of lateral profile 05 in the end area in a visually appealing manner. By means of snap arm 81, end lid 08 can be fixated at upper end 52 of lateral profile 05 via a snap connection at lateral profile 05. For this purpose, end lid 08 can be inserted into lateral profile 05 until snap element 83 disposed on snap arm 81 engages in snap opening 54 of lateral profile 05. Tension fitting 10 has tension shoe cap adapter 102 and tension shoe cap 101, at which tension cord 09 can be fastened. As shown in FIG. 8, tension shoe cap 101 is connected to tension shoe cap adapter 102 by means of a snap connection. In this context, tension shoe cap 101 is disposed within tension shoe cap adapter 102, meaning tension shoe cap adapter 102 encloses tension shoe cap 101 on three sides. Tension fitting 10 can be connected to end lid 08 also by means of a snap connection. For this purpose, tension shoe cap adapter 102 has two snap protrusions 103, which can snap into snap recesses in end lid 08 in order to ensure that the connection between tension fitting 10 and end lid 08 cannot be manually disconnected. In order to further increase the safety of the connection between tension fitting 10 and end lid 08, tension shoe cap adapter 102 moreover has an inclination 104. Inclination 104 is designed such and interacts in such a manner with end lid 08 that when attempting to detach tension shoe cap adapter 102 from end lid 08, tension shoe cap adapter 102 and thus the entire tension fitting 10 are first pushed towards end surface 84 of end lid 08, whereby the tension of tension cord 09 is first further increased and the detachment of tension shoe cap adapter 102 from end lid 08 is encumbered. This can be seen in particular in the cut view shown in FIG. 9, in which tension fitting 10 is shown connected to end lid 08. Inclination 104 rises towards end wall 105 of tension fitting 10. Tension shoe cap 101 serves for fixating tension cord 09. For this purpose, tension shoe cap 101 can have fastening hooks, at which tension cord 09 can be fixated. FIGS. 12 to 15 show different options for mounting lateral profiles 05. As shown in FIGS. 12 and 13, the use of an adhesive connection is possible for mounting lateral profiles 05, an adhesive medium 12 being applied to an outer surface of lateral profile 05. In this context, a two-sided adhesive adhesion strip can be used as an adhesive medium 12, which allows mounting lateral profile 05 without tools. Furthermore, as shown in FIGS. 14 and 15, a stable mounting of lateral profiles 05 is enabled by means of a screw connection. For this purpose, a screw 14 passes through a wall of lateral profile 05. Both the screw connection and the adhesive connection allow a front mounting (compare FIGS. 12 and 14) and an alcove mounting (compare FIGS. 13 and 15). The front mounting serves for mounting plissé installation 01 directly at the surface to be shaded, such as a window frame or a window sash, adhesive medium 12 being disposed on a rear wall of base body 55 of lateral profile 05 or screw 14 passing through a rear wall of base body 55 of lateral profile 05. In the shown exemplary embodiment, the rear wall is the wall of base body 55 which is enlarged by covering leg 56. In order to reach screw 14 disposed at the rear wall, an additional screw opening, which can be a drill hole and is covered by covering cap 15, is introduced in the opposite wall of base body 55, as shown in FIG. 14. In contrast, adhesive medium 12 or screw 14 is disposed at a lateral wall of base body 55 of lateral profile 05, which is positioned opposite opening 51, for the alcove mounting. The alcove mounting advantageously allows mounting plissé installation 01 to a wall or a different building structure, which includes the surface to be shaded, in particular at an alcove, lateral profiles 05 not being applied directly at the surface to be shaded, but preferably one lateral profile 05 being applied on each side of the surface to be shaded.

1. A plissé installation (01) for window and door openings, the plissé installation comprising two profile rails (02, 03) including an upper rail (02) and a lower rail (03) between the both of which a sun protection device (04) adjustable in size is disposed, and further comprising a lateral profile (05) disposed perpendicular to the longitudinal extension of the profile rails (02, 03), the profile rails (02, 03) being disposed on a tension cord (09) so as to be freely displaceable independently of each other along the longitudinal extension of the lateral profile (05), and the tension cord being directly or indirectly fastenable within the lateral profile, wherein a guide blade (06) is disposed on the profile rails (02, 03), the guide blade (06) protruding into the lateral profile (05) via an opening (51) of the lateral profile (05) in order to guide the profile rails (02, 03 along the lateral profile (05), and the tension cord (09) being guided through the sun protection device (04), through the lateral profile (05) and through the profile rails (02, 03) so as to be inaccessible.

2. The plissé installation according to claim 1, wherein the guide blade (06) is disposed on an end cap (11, 12) disposed on a front face on the profile rails (02, 03), the guide blade (06) preferably being formed in one piece with the end cap (11, 12).

3. The plissé installation according to claim 1, wherein the opening (51) in the lateral profile (05) extends over the entire longitudinal extension of the lateral profile (05).

4. The plissé installation according to claim 1, wherein the guide blade (06) has a recess (61) for guiding the tension cord (09).

5. The plissé installation according to claim 1, wherein an end lid (08) is disposed on a front face (52, 53), in order to fasten a tension fitting (10) for the tension cord (09).

6. The plissé installation according to claim 1, wherein the tension fitting (10) has a tension shoe cap (101) and a tension shoe cap adapter (102) for fastening the tension cord (09) within the lateral profile (05), the tension shoe cap (101) and the tension shoe cap adapter being connectable to one another or the tension shoe cap (101) being formed in one piece with the tension shoe cap adapter (102).

7. The plissé installation according to claim 1, wherein the tension shoe cap adapter (102) is connectable to the end lid (08) by means of a snap connection.

8. The plissé installation according to claim 1, wherein the end lid (08) has a snap arm (81) which is engageable in a snap opening (54) of the lateral profile (05).

9. The plissé installation according to claim 1, wherein the tension fitting (10) is disposed within the lateral profile (05) so as to be inaccessible or the lateral profile (05) ends flush by means of the end lid (08).

10. The plissé installation according to claim 1, wherein a handle element (13) for adjusting the height of the profile rails (02, 03) is disposed on the profile rails (02, 03), the handle element (13) being fastened on the profile rails (02, 03).

11. The plissé installation according to claim 1, wherein the connection between the lateral profile (05) and the end lid (08) or the connection between the handle element (13) and the profile rail (02, 03) or the connection between the end cap (11, 12) and the profile rails (02, 03) or the connection between the tension shoe cap adapter (102) and the end lid (08) is designed so as to not be manually disconnectable.

12. The plissé installation according to claim 1, wherein the lateral profile has an essentially C-shaped base body, a cover leg protruding from the base body of the lateral profile towards the profile rails.

13. The plissé installation according to claim 1, wherein the guide blade (06) and the end lid (08) are connectable to one another by means of a disconnectable snap connection, the guide blade (06) being brought into contact at an undercut (82) of the end lid (08).

14. The plissé installation according to claim 1, wherein two lateral profiles (05) are comprised and the clear width (B_{L}) between the two lateral profiles (05) is maximally twenty millimeters wider than the length (L_{P}) of the profile rails (02, 03).

15. The plissé installation according to claim 1, wherein the plissé installation (01) has two lateral profiles (05), four end lids (08) and four tension fittings (10).
